(19) United States
(12) Patent Application Publication
(10) Pub. No.: US 2009/0094072 A1
(43) Pub. Date: Apr. 9, 2009

(54) System for golf reservations

(76) Inventor: Bob Rodenberg, Palm Beach, FL (US)

Correspondence Address: MCHALE & SLAVIN, P.A., 2855 PGA BLVD, PALM BEACH GARDENS, FL, 33410, US

(21) Appl. No.: 12/121,401

(22) Filed: May 15, 2008

Related U.S. Application Data
(60) Provisional application No. 60/977,771, filed on Oct. 5, 2007.

(51) Int. Cl. G06Q 10/00

(52) U.S. Cl. 705/5; 705/1

(57) ABSTRACT

A system and method for making reservations, in particular golf tee times, utilizing the Internet is disclosed. The system provides a user with access to a reservation system of a particular location, such as a golf course. The user is able to make and confirm a reservation for an event, such as a tee time, from anywhere. The system can also employ Voice Over Internet Protocol (VoIP) to enable a user to make and confirm a reservation for an event by dialing a local phone number.

### RELATED APPLICATIONS

The present application claims priority under 35 U.S.C. 119(e) of U.S. Provisional Application Ser. No. 60/977,771, filed on Oct. 5, 2007 and entitled “VOIP & INTERNET WEB PAGE TEE TIME RESERVATIONS”, the entirety of which is incorporated herein by reference.

### FIELD OF THE INVENTION

The present invention relates to systems and methods for obtaining reservations for particular events. More specifically the present invention relates to a system and method for obtaining reservations for tee times at golf courses.

### BACKGROUND OF THE INVENTION

Reservations for playing golf at specific golf courses have been a time consuming and inconvenient matter for individuals. Normally reservations are made on a first-come first-served basis. Thus the individual or individuals must go to the clubhouse at a particular golf course to make a reservation to play golf on a specific day and at a specific time. This is very inconvenient for many individuals with full time jobs or those who do not have ready access to the golf course. For example, an individual may be planning a vacation or business trip to another location and desire to play golf with friends or business associates at this other location. The only possible way to make a reservation for a specific tee time, in this situation, would be to phone the golf course and hope that they record and honor the reservation. There is no assurance, other than a verbal assurance, that the reservation the individual has requested has actually been made and recorded. In addition, at very popular golf courses reservations are allocated to individuals through a lottery system, wherein individuals must register in the lottery and a drawing is held at a specific time. Individual at locations away from the golf course may not be able to register in the lotteries. In addition, in most instances the individuals must physically go to the golf course to receive their tee time.

Accordingly, there exists a need for a system and method for an individual to make a reservation to play golf at a specific golf course for a specific day and time. In addition, there exists a need for the individual to receive a confirmation of the reservation other than a verbal confirmation.

### DESCRIPTION OF THE PRIOR ART

U.S. Pat. No. 5,596,636 discloses a device for making reservations for tee times at a specific golf course. The device or “Teephone” is connected to a conventional touch-tone phone line. The “Teephone” can dial and connect to automated reservation systems at golf courses. An individual desiring a tee time reservation programs the “Teephone” with the phone number of a specific golf course and the tee time or times desired. The “Teephone” will call the golf course automated reservation system at a specific time and submit the requested tee time reservation. If the reservation is made a confirmation is displayed on a screen on the “Teephone”. This device does not enable an individual to see all of the tee times that are available on specific days. Many individuals have flexible schedules and are able to play golf at times other than their preferred time or first choice.

Accordingly, there exist a need for a system and method for an individual to make a tee time reservation to play golf at a specific golf course and be aware of all the different tee times which are available prior to making the reservation.

### SUMMARY OF THE INVENTION

A system and method for making reservations, in particular golf tee times, utilizing the Internet. The system provides a user with access to a reservation system of a particular location, such as a golf course. The user is able to make and confirm a reservation for an event, such as a tee time, from anywhere. The system also employs an integrated Voice over Internet Protocol (VoIP) to enable a user to make and confirm a reservation for an event by dialing a local phone number.

Accordingly, it is an objective of the instant invention to provide a system for making reservations for events using the Internet.

It is a further objective of the instant invention to provide a system for making reservations for an event utilizing a phone and Voice over Internet Protocol (VoIP).

It is yet another objective of the instant invention to provide a system for making reservations located in a central location and connected to a plurality of diverse locations at which a plurality of different events will occur.

It is a still further objective of the invention to enable a user to make a reservation over the phone at a distant location without having to dial a long distance phone number or a toll free number.

It is still a further objective of the invention to enable a golf course or other venue to utilize an automated reservation system without having the expense of the hardware and maintenance associated with an in-house system.

It is still yet another objective of the invention to enable a golf course or other venue to utilize an automated reservation system which can include a plurality of work stations positioned at various locations on-site of the golf course or other venue without the need for a LAN (local area network).

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a block diagram of the operating system of the present invention;

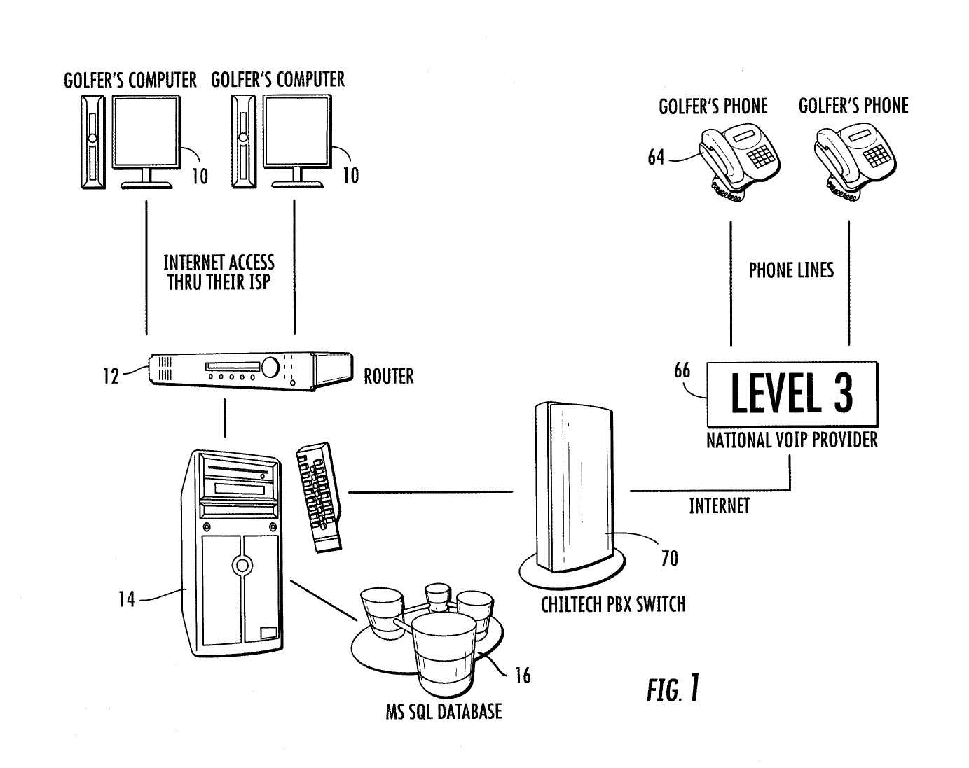

FIG. 2 is a web page for making an online reservation;

FIG. 3 is a web page indicating the dates and times available for an online reservation;

FIG. 4 is a web page indicating a specific reservation which a user has made;

FIG. 5 is a web page wherein the players names of a group for a reservation are entered;

FIG. 6 is another example of a web page wherein the players names for a group are entered;

FIG. 7 is a web page indicating all the reservations that have been made for a user;

FIG. 8 is a web page indicating the golf scores of a user;

FIG. 9 is a web page indicating other events occurring at a particular golf course or other venue; and

FIG. 10 is a web page for entering for entering specific information for a user.

### DETAILED DESCRIPTION OF THE INVENTION

The present invention is directed to a system or business for making reservations for golf games or other events which reduces the user's inputs to a common interface which is relayed to various venues at different geographic locations. In particular the present invention enables a user to contact a plurality of golf courses located at various geographical locations. The users are connected to a central server via the Internet. The central server enables players or user to make reservations for tee times for golf games without having to go to or call specific golf courses. The user can connect to the central server using the Internet or a public telephone system. In addition to golf games reservations can be made for other events such as sporting events, concerts, movies, restaurant or any event wherein reservations are accepted.

When a user desires to make a reservation for a tee time at a particular golf course they will log onto their computer or terminal 10 wherever they are. They can be at home or anywhere they can obtain Internet access through an Internet Service Provider (ISP). With a laptop computer and wireless Internet service the user can be at any location around the world. The various Internet connections are sent through a router 12 to a central server 14. The various golf courses or other venues which accept reservations for upcoming events are also connected to the router through the Internet. A database 16 stores all the necessary information required to make the reservations. Once the reservation is made the server 14 contacts the particular golf course or other venue and sends them the information regarding the reservation or reservations. The golf course can then confirm the reservation in their on-site system and send a confirmation back to the user. The golf course can also utilize this system to confirm the cancellation of a tee time or other event.

At any time prior to the actual tee time or other reservation the user may change or cancel the reservation. This permits the golf course or other venue to allow other users or individuals to reserve the cancelled tee time or cancelled reservation. Certain golf courses or other venues may impose certain conditions regarding the cancellation or rescheduling of reservations. These conditions can be stored at the central database 16 or sent to the user from the specific golf course or other venue.

Another feature of the present invention is that a plurality of workstations or kiosks can be placed at various locations at a particular golf course, country club, restaurant, etc. The various workstations or kiosks enable an individual to log onto the system to check the information pertaining to them. The various locations also enable employees of the golf course, country club, etc. to log onto the system to process the reservations requests. Since the system utilizes the Internet a LAN (local area network) is not required to link the workstations or kiosks.

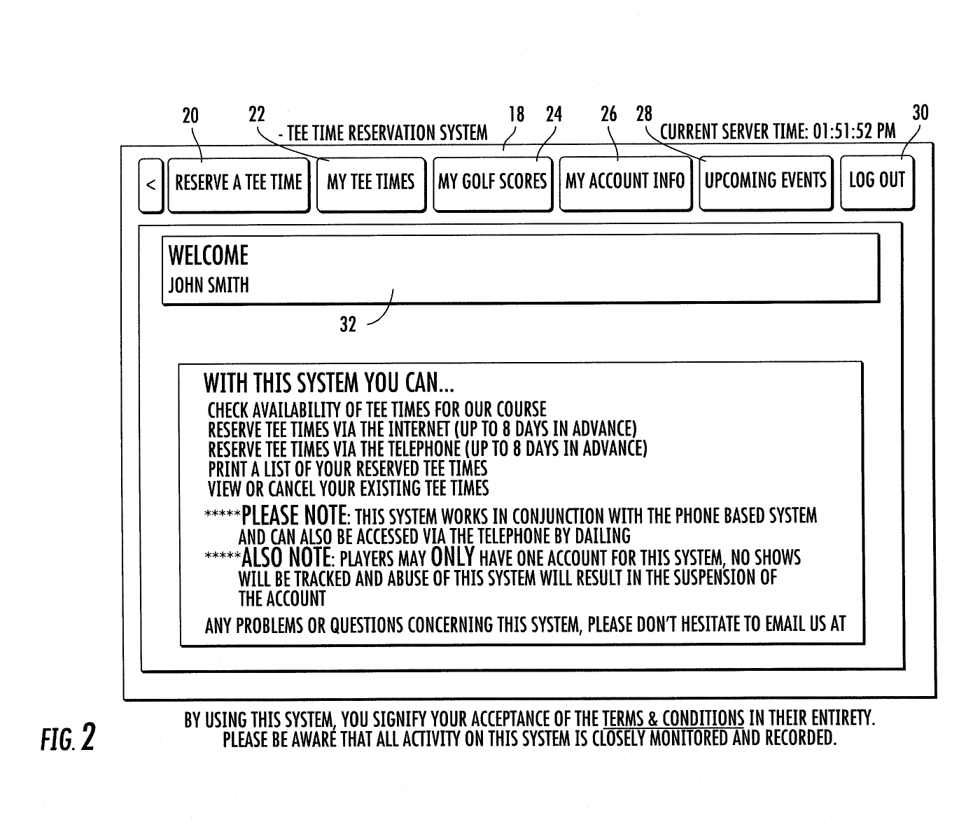

The central server 14 will preferably provide a Graphical User Interface (GUI) for a user to readily make their reservation. In a preferred embodiment the user will access a particular golf course or other venue over the Internet. They can then click on a link which connects them to the reservation system of the present invention. Next the user will enter their e-mail address and password to gain access to the system. FIG. 2 is an example of a GUI that will be presented to a user upon registration with the system. At the top of the web page there is a menu 18 that enables the user to select which transaction they desire. For example they can make reservation for a tee time by selecting the “Reserve a Tee Time” button. They can also view a record of the tee times that they currently have reserved by selecting the “My Tee Times” button 22. They can view their past golf scores by selecting the “My Golf Scores” button 24. They can check or change their account information by selecting the “My Account Info” button 26. They can check for upcoming events by selecting the “Upcoming Events” button 28. Finally, they can log out of the system by selecting the “Log Out” button 30.

Below this menu is a banner 32 which indicates the user's name. Below this is a plurality of choices or links which enable a user to perform various tasks. The first choice enables a user to check on the tee times which are currently available. The next choice enables the user to reserve a tee time or make a reservation for an event over the Internet. In the embodiment illustrated, the particular golf course will only reserve a tee time 8 days in advance. The next choice enables the user to make a reservation using a telephone. This will be described later. The next choice enables the user to print a list of the tee times which they have currently reserved. The final choice enables the user to view or cancel their reserved tee times. This web page also provides a phone number the user can call to make a reservation.

In the event that there is a plurality of golf courses at a single location the system can be programmed to select the golf course which offers the individual a tee time closes to his/her request. The system can also be programmed to prioritize the tee times based of a particular golf course selection. Also, if an individual or company owns or operates a plurality of golf courses or other establishments, such as restaurants, and they are located within a given area, for example a 5 mile radius, all of the golf courses, restaurants, etc. can be linked to a single account so that when an individual desires a tee time or restaurant reservation all of the different golf courses or restaurants will be searched to see which one can offer a time closes to the time the individual desires. In addition, a plurality of owners of different golf courses, restaurants, etc. can decide to pool their resources and share one account so that an individual seeking a particular tee time or reservation has all of the golf courses, restaurants, etc to choose from with one request.

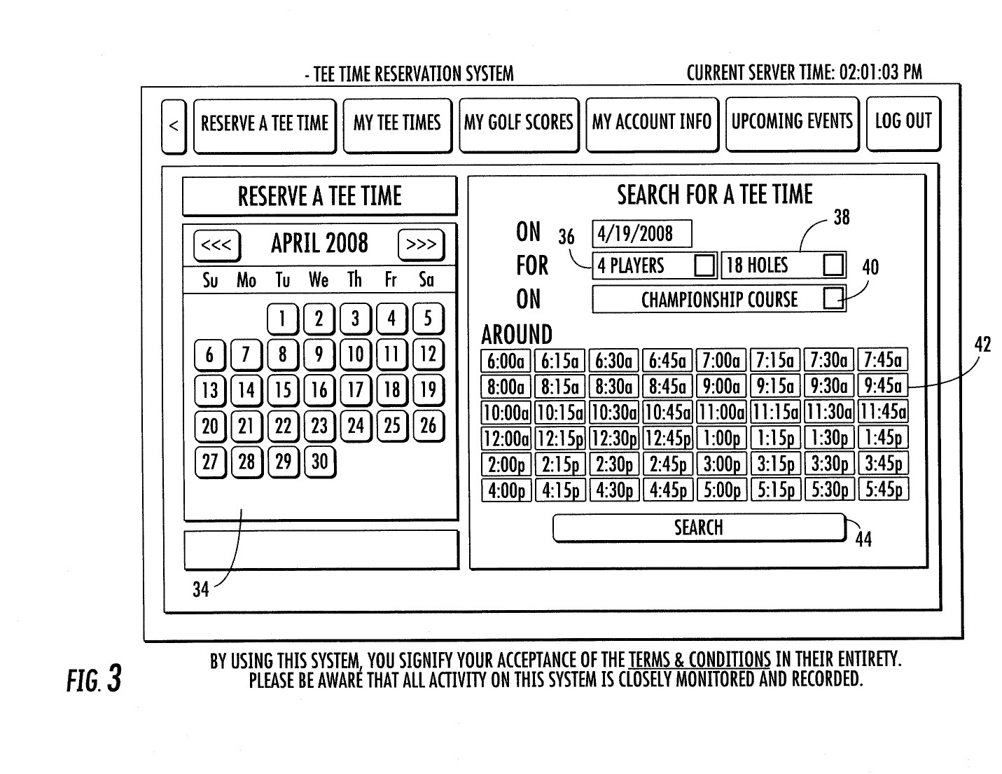

FIG. 3 is a web page which illustrates the tee times which are available. It can also display dates available for other events such as sporting events, concerts, etc. The user can select from a calendar 34 a specific day in a specific month. The available dates are usually highlighted. Once this selection is made the date will appear on the right side of the screen. The user can then indicate in 36 if they will have 2 or 4 players. They can then select at 38 if they want to play 9 or 18 holes of golf. Next they can indicate at 40 which course they want to play on. If only one course is available this choice will not be available. They can then select a specific tee time from those available at 42. In certain embodiments the available tee times can be highlighted or the previously reserved tee times can be highlighted. Once the user selects a specific tee time they will select the “search” button 44 to make the reservation.

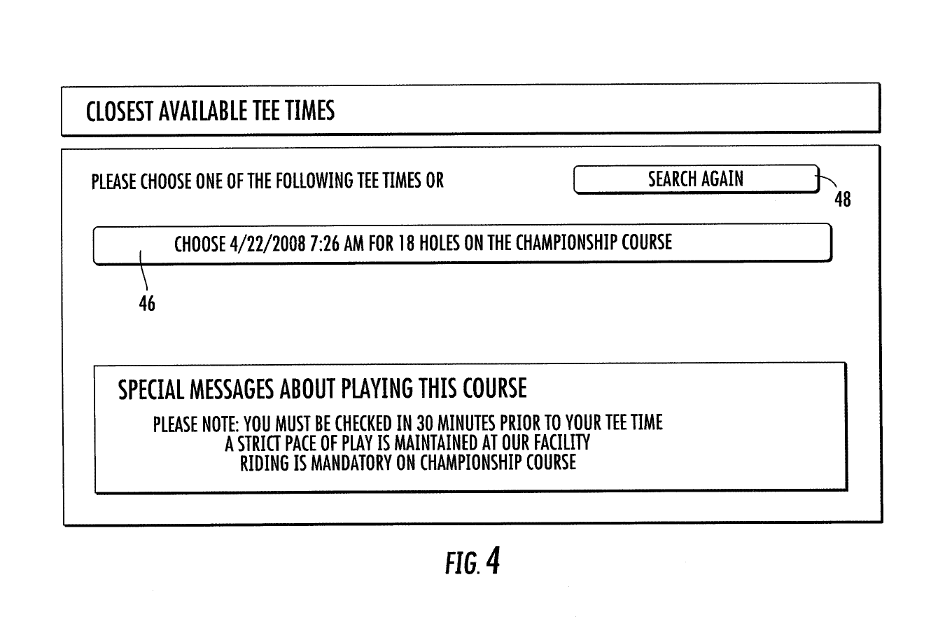

FIG. 4 is a web page which appears next. This indicates at 46 if the desired tee time is available or the next closest tee time which available. If the user is satisfied with the tee time which is indicated they will click on button 46. If they want to make another selection they can return to the previous web page or screen by selecting button 48. This web page can also provide specific information concerning the reservation. For example, the user and their party must check in at the clubhouse or other location specified 30 minutes prior to their tee time. Another requirement is that a golf cart must be used when playing the championship course.

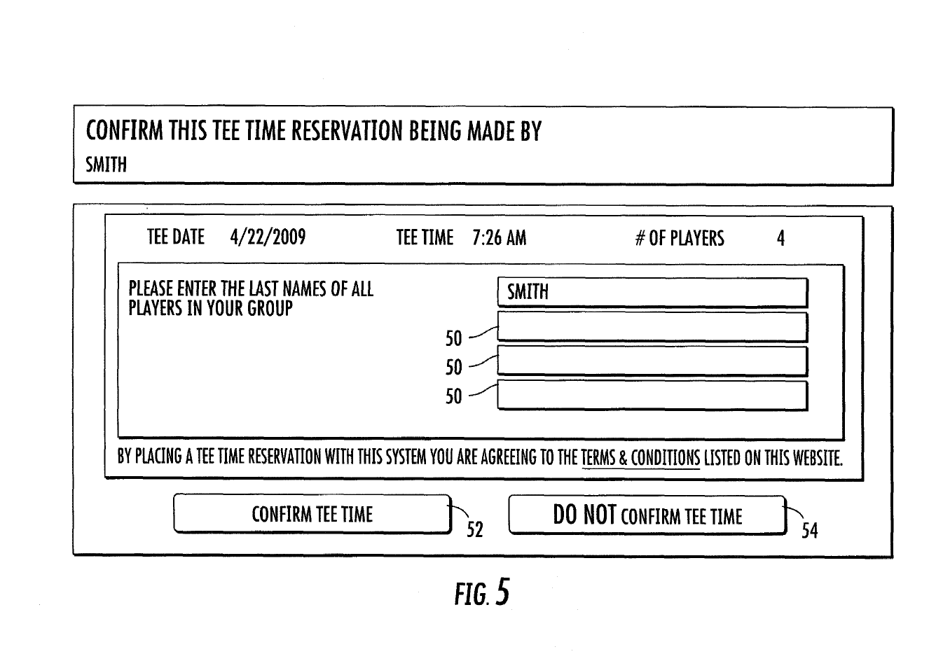

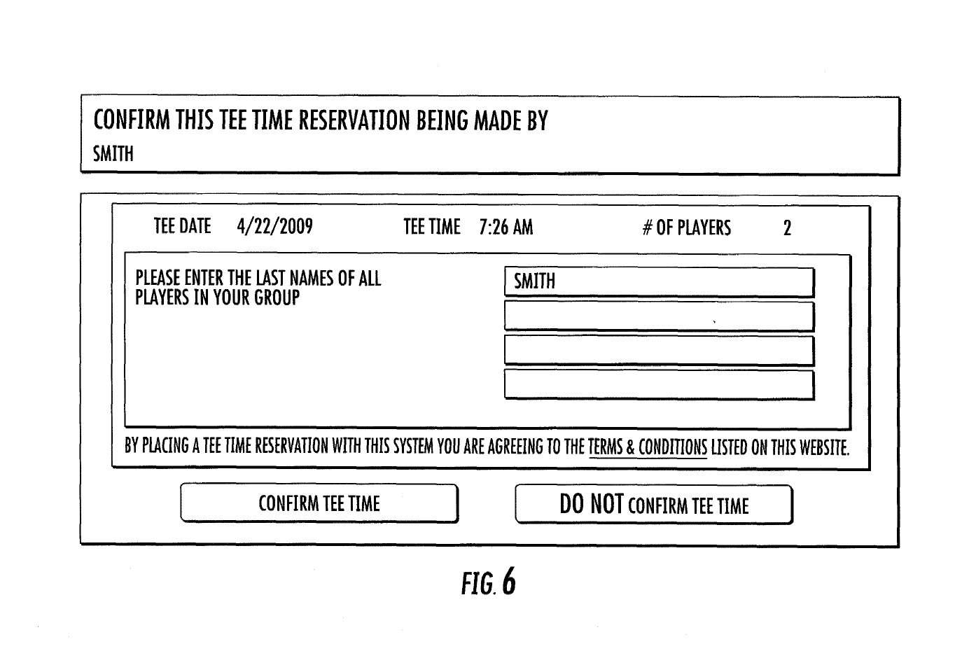

FIG. 5 is a web page or screen which appears next. On this page the user's name appears and they will then enter the names of the other players in their group in the areas provided at 50. They can then confirm the reservation by selecting button 52 or start again by selecting button 54. FIG. 6 is a web page similar to FIG. 5 wherein there are only two players in the group.

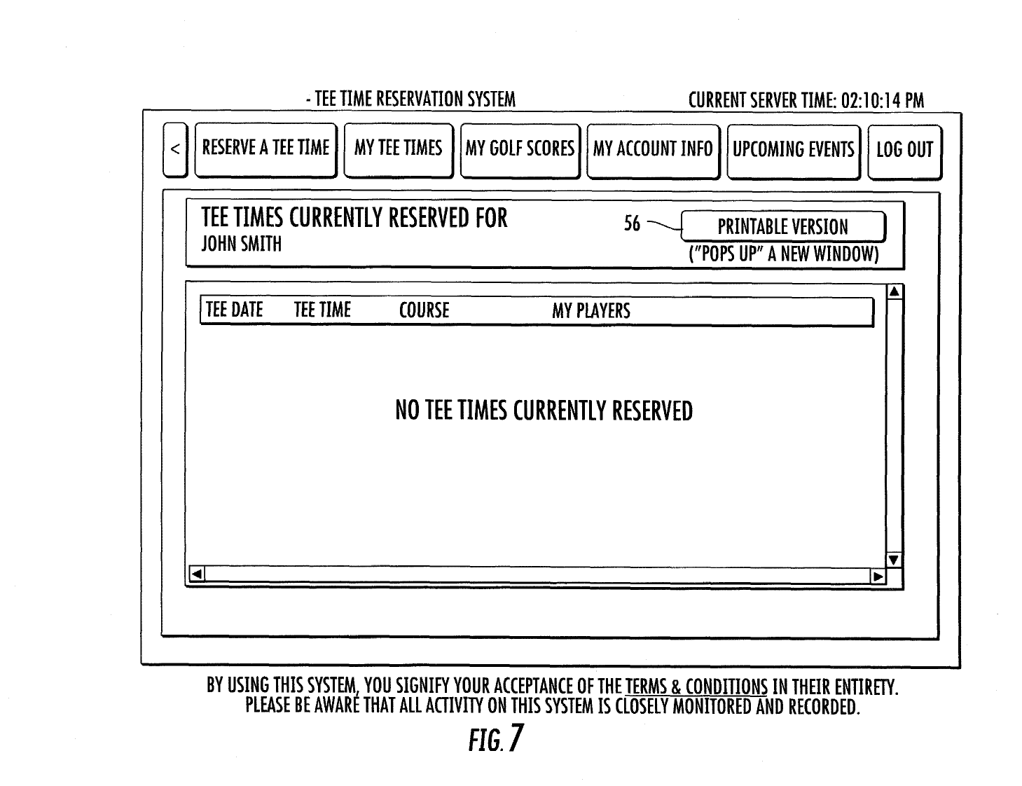

FIG. 7 is the web page or screen which appears when a user selects button 22 from the menu at the top of the screen illustrated in FIG. 2. This web page displays the dates, tee times, golf course name, and players for which the user has current reservations. The user can print out a paper copy of the reserved times by selecting button 56.

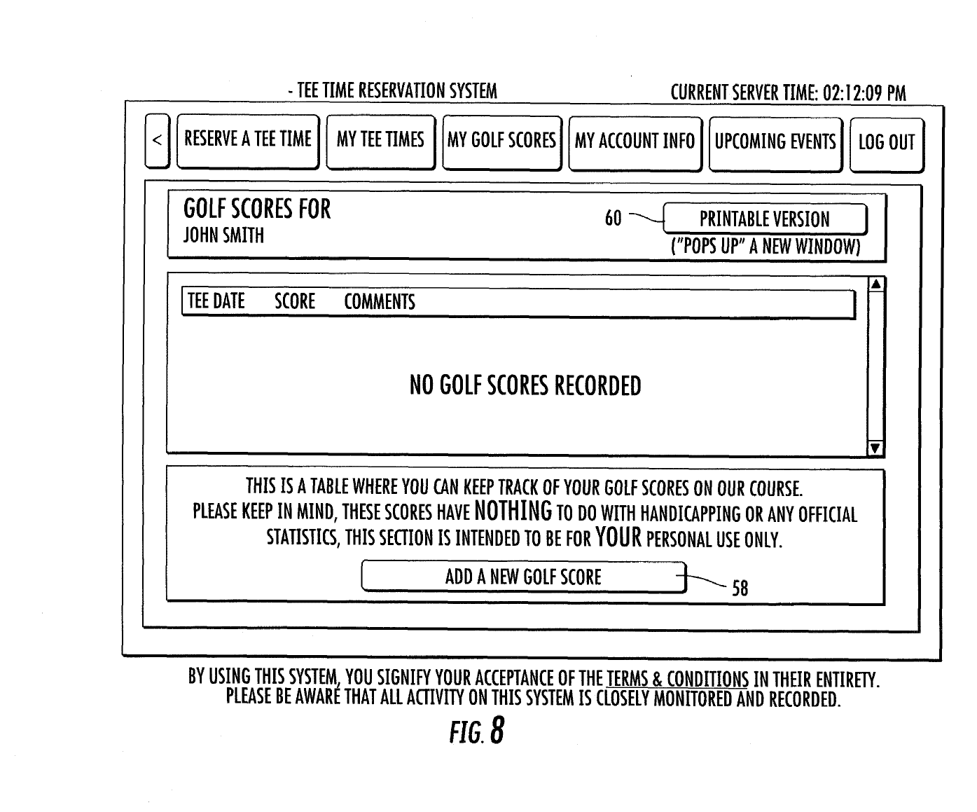

FIG. 8 is the web page or screen which appears when a user selects button 24 from the menu at the top of the screen illustrated in FIG. 2. The user's past golf scores are displayed. New golf scores can be entered by selecting button 58. The user can print out a paper copy of he scores by selecting button 60.

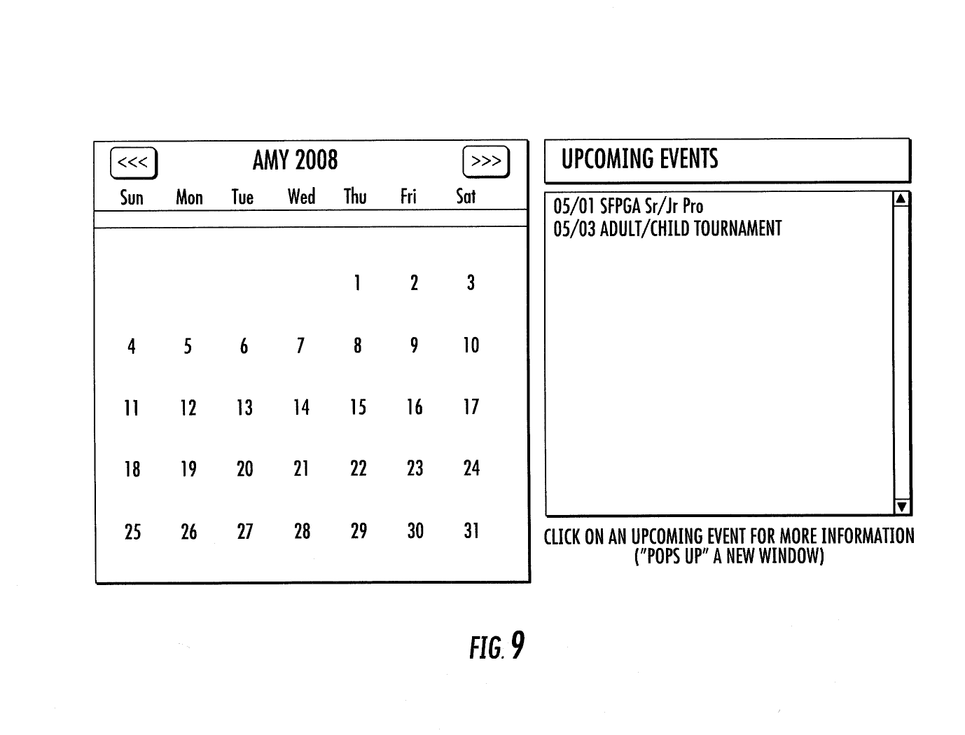

FIG. 9 is the web page or screen which appears when a user selects button 28 from the menu at the top of the screen in FIG. 2. FIG. 9 is a display of upcoming events at a particular golf course. If the user is logged onto a web site or venue for a sporting event or other event, the upcoming events at that particular venue will be displayed. This enables the user to view future sporting events, concerts, etc. The specific events illustrated on the right side of the screen can be links to the specific events. By selecting the specific event the user can obtain further information concerning the event.

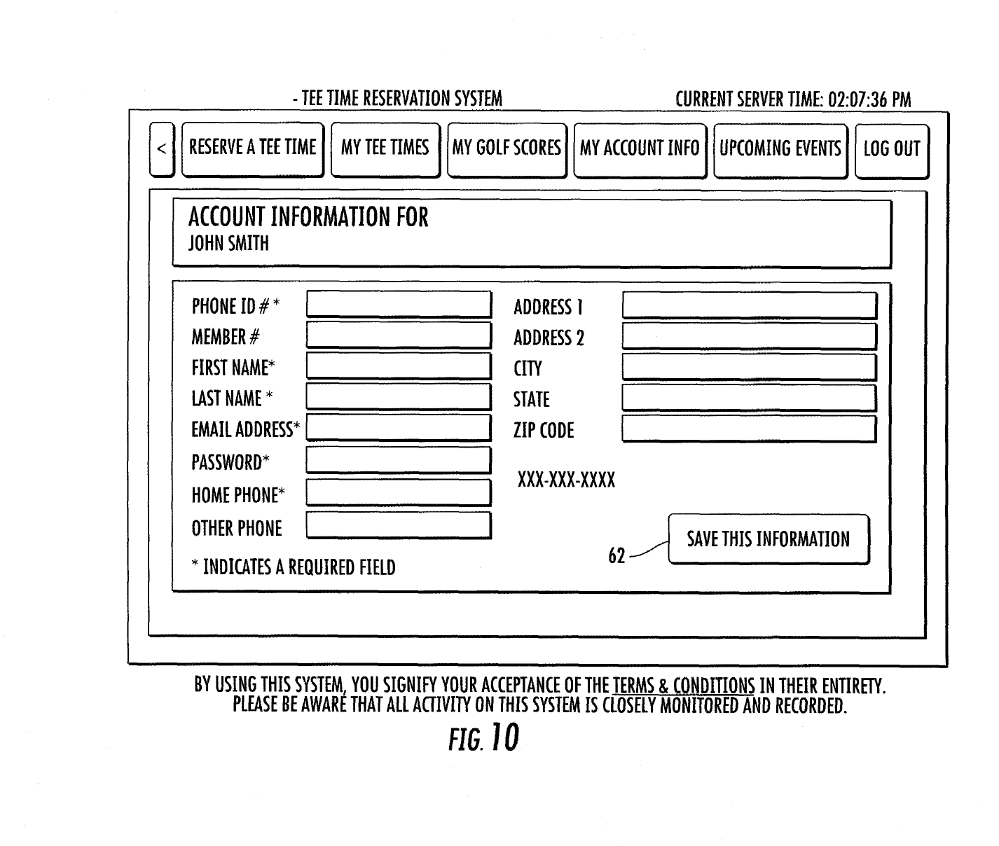

FIG. 10 is the web page or screen which appears when a user selects button 26 from the menu at the top of the screen in FIG. 2. The user can enter or change the information relating to their account at this screen. After the information is entered or changed the user selects button 62 to save this information to the database 16 or other location established by the system. For example all or a portion of this information can be stored at a particular golf course or other venue.

Golf tee times or other reservations can also be made over a telephone 64. The telephone 64 may also be referred to as a user terminal. The telephone 64 may be a landline phone, a cellular phone or a satellite phone. Any phone which is capable of operating with the voice recognition system employed by the invention can be used. When the user desires to make a reservation they will dial a local phone number which connects them via a public switched telephone network, or similar system, to a voice over internet protocol (VoIP) provider 66. The local phone number utilizes DID (direct inward dialing) whereby the phone company allocates a range of phone numbers all connected to a customer's PBX. As the calls are presented to the PBX, the number that the caller dialed is also given, so the PBX can route the call to the desired person within the organization. In order for individuals connected to a traditional PSTN network to call individuals connected to VoIP networks, DID numbers from the PSTN network are obtained by the administrator of the VoIP network and assigned to a gateway in the VoIP network. The gateway will then route calls incoming from the PSTN across the IP network to the appropriate VoIP user. Similarly, calls originating in the VoIP network will appear to users on the PSTN as originating from one of the assigned DID numbers. This avoids the need for an 800 toll free number or the user having to dial a long distance phone number. They are then connected via the Internet to a telephone exchange 70. The telephone exchange 70 is connected to the server 14. The connection between the exchange 70 and the server 14 is preferably made utilizing a Primary Rate Interface (PRI) connection. Other types of connections are also possible. Once the user is connected they can enter their PIN number to access their account. Their account can initially be set up over the phone or over the Internet as previously described. Utilizing voice prompts and a touch tone phone the user can make a reservation for a tee time or other event. The system will provide voice prompts and voice menus to guide the user through the reservation process. If the user is making a reservation for a tee time the names of the players in the group are normally required. The user will speak their names into the phone and voice recognition software will enter this information into the database. The spelling of he names is confirmed by the voice recognition software, an operator or the user may have to provide the spelling of the names. In another embodiment, the employees of the golf course or restaurant will make a WAV file from the audio of the phone reservation. They can download this on a computer and analyze it for the correct name spellings. They can then enter these names into the reservation system in the proper account. They will receive a confirmation over the phone of the reservation. They can also receive a confirmation via e-mail, through the regular mail, by a text message on a cellular phone, etc. In addition to voice prompts, other voice or tone activated systems can be employed to make the reservations.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A reservation system for implementing real time access to a plurality of individual, diverse locations, said system comprising:
a user terminal;
a first communication interface connecting said user terminal to a reservation system;
said reservation system connected to a plurality of different venues by a second communication interface, said reservation system providing said user with access to a plurality of events;
said user terminal constructed and arranged to enable said user to view and select one of said plurality of events;
said reservation system communication a confirmation of said user selection to said user terminal through said communication interface.

2. The system of claim 1 wherein said first and said second communication interfaces are the Internet and said user terminal both transmits data and receives data.

3. The system of claim 2 wherein said terminal includes a graphical user interface.

4. The system of claim 1 wherein said reservation system includes a server, said server is in communication with at least one of a plurality of different venues, said different venues are located at the sites of said available events;
said reservation system further including a database connected to said server.

5. The system of claim 4 wherein said database of reservation system contains information including at least one of a reservation time for an event, all of the reservations relating to said user and said user's scores in a game.

6. The system of claim 4 wherein said reservation system includes information including at least one of a reservation time for an event, all of the reservations relating to said user and said user's scores in a game, said information is stored at said different venue.

7. The system of claim 5 wherein said information is a reservation time for a golf game and said user's scores are golf scores.

8. The system of claim 1 wherein said user terminal is a telephone, said second communication interface is a public switched telephone network and the Internet, said user terminal both transmits data and receives data.

9. The system of claim 8 wherein said telephone communicates with said reservation system using Voice over Internet Protocol (VoIP).

10. The system of claim 8 wherein said second communication interface includes a telephone switch, said telephone switch connects the Internet to said server.

11. The system of claim 8 wherein a voice activated communication system is connected to said server, said voice activated communication system accepting input from said user and converting said input to usable data in said server.
